(19) United States
(12) Patent Application Publication
(10) Pub. No.: US 2017/0186120 A1
(43) Pub. Date: Jun. 29, 2017

(54) Health Care Spend Analysis

(71) Applicant: Cerner Innovation, Inc., Kansas City, KS (US)

(72) Inventor: Kimberly Jo Reid, Kansas City, MO (US)

(21) Appl. No.: 14/982,970

(22) Filed: Dec. 29, 2015

(51) Int. Cl. G06Q 50/22; G06Q 30/02; G06F 19/00

(52) U.S. Cl. CPC G06Q 50/22; G06F 19/322; G06Q 30/0202

(57) ABSTRACT

Methods, systems, and computer-readable media are provided for health care spend analysis using data from claims in combination with demographic information, medical condition information, wellness program information, and the like. In addition to using this information to identify health care spend values, secondary outcomes may be identified such as overall effects on health. The health care spend tool provides the ability to manipulate multiple inputs to identify changes in health care spends.

### BACKGROUND

Heath care expenses are rising and, with increasing costs, it is essential to be aware of future health care costs. Cost predictive systems are helpful for identifying costs associated with patient populations. But present systems for predicting health care spend (i.e., cost) are limited with respect to the inputs they can evaluate. For instance, present systems do not provide capabilities to input demographic information, medical condition information, and wellness program information. As a result, there is not an array of inputs to customize, which doesn't allow for customization of outcomes. This may result in unnecessary spend/costs per population or for each individual within the population. Various adjustable inputs within a single program allows health care clients to identify variables that have a greater impact on spend/cost and focus resources on those variables that make a greater difference and have a higher return value.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present disclosure relate to systems, methods, and user interfaces for providing average health care spend for a population. A predictive model is provided herein that may use information from claims, clinical data, electronic medical records (EMR), wellness information, and the like to identify populations of individuals. The predictive model may be provided in a web-based interactive interface. The predictive model may predict, among other things, estimated average member per year claims spend (PMPY) and total cost savings. Additionally, program values, such as demographic information, medical condition information, and wellness program information are modifiable such that users can manipulate the variables to see which modifications have a greater impact on spend.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing environment suitable to implement embodiments of the present invention;

FIG. 2 is a block diagram of an exemplary system suitable to implement embodiments of the present invention;

FIG. 3 is an exemplary graphical user interface suitable to provide a customizable spend calculator program, in accordance with an embodiment of the invention;

FIG. 4 is an exemplary graphical user interface illustrating a modification of program values, in accordance with embodiments of the invention;

FIG. 5 is a flow diagram of an exemplary method for predicting health care spend, in accordance with embodiments of the invention; and

FIG. 6 is a flow diagram of an exemplary method for predicting health care spend, in accordance with embodiments of the invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

As one skilled in the art will appreciate, embodiments of our invention may be embodied as, among other things: a method, system, or set of instructions embodied on one or more computer readable media. Accordingly, the embodiments may take the form of a hardware embodiment, a software embodiment, or an embodiment combining software and hardware. In one embodiment, the invention takes the form of a computer-program product that includes computer-usable instructions embodied on one or more computer readable media.

Computer-readable media can be any available media that can be accessed by a computing device and includes both volatile and nonvolatile media, removable and non-removable media. By way of example, and not limitation, computer-readable media comprises media implemented in any method or technology for storing information, including computer-storage media and communications media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. In one embodiment, computer storage media excludes signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Accordingly, aspects of the technology described herein are directed towards systems, methods, and computer storage media for, among other things, providing a health care spend value. In particular, embodiments may determine an average member cost for each member of, for example, a population. A total cost savings may also be determined. The spend values (total cost, average cost, etc.) may be determined utilizing various inputs such as demographic inputs, medical condition inputs, wellness program inputs, and the like.

Accordingly, at a high level and in some embodiments, one or more predictive models are provided that may use information from claims, clinical data, demographic information, electronic medical records (EMR), and wellness information, which may include personal health assessments (PHA) to predict future spending levels.

The predictive model(s) may be applied to a population of patients to determine a health spend for either a population or an individual basis, or a combination thereof. In some embodiments, the population spend values may be displayed to an administrator or clinician to facilitate decision making. In this way, embodiments of the present disclosure can provide an improved understanding of the patient population and spend associated therewith, thereby enabling administrators to more efficiently target individual patients for intervention and develop wellness programs targeting population-specific conditions. Additionally, the customization of the present invention enables users to quickly identify which modifications will positively impact a population spend value and allows users to more effectively focus resources.

As described previously, present approaches for identifying health care spend are based largely on medical claims data and do not harness other information, such as valuable electronic health record data, demographic information, wellness/PHA information, or other claims experience for categorizing patient risks. Present approaches also lack the ability to modify these inputs (e.g., claims data, wellness program data) to evaluate their impact on overall spend. As a result, inaccurate spend values are generated, rendering the previous approaches less effective at understanding the population.

In contrast to all of these approaches, embodiments of the disclosure take a different approach to the problem, include other patient data (such as EMRs, demographic information, or Wellness/PHA records, for example), and are thus able to provide more accurate model(s) that can be used to predict health care spend on both the population level and the individual level.

Having briefly described embodiments of the present invention, an exemplary operating environment suitable for use in implementing embodiments of the present invention is described below.

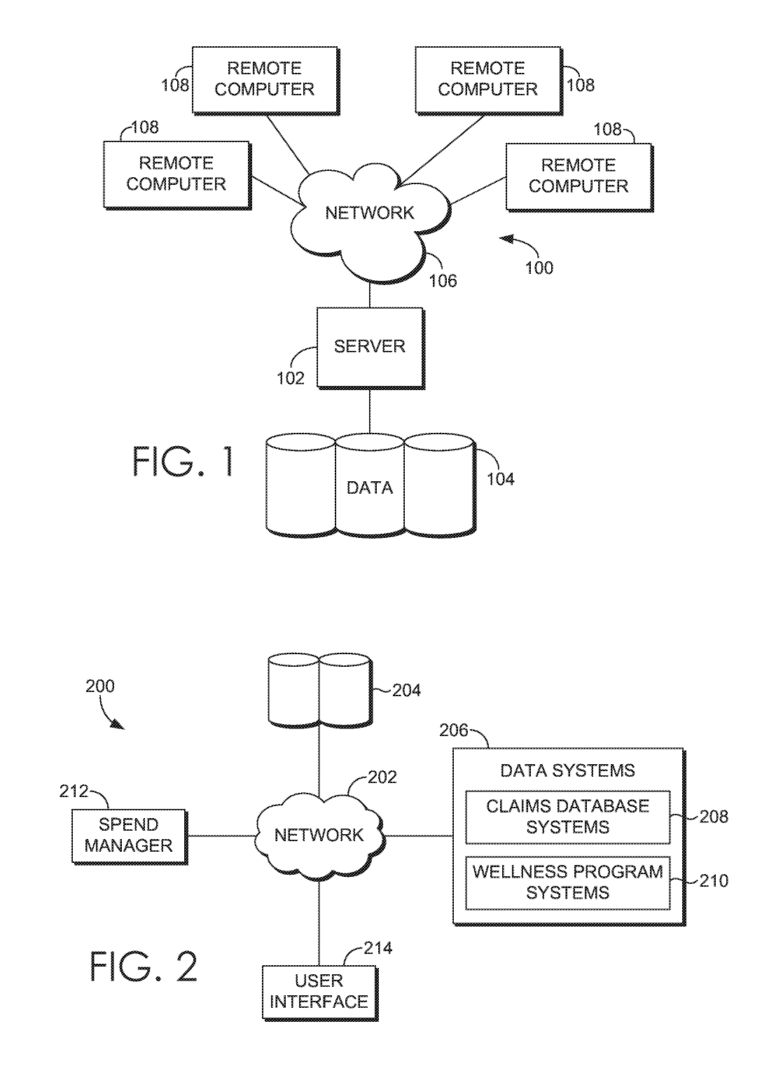

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention is a special computing system that can leverage well-known computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices, memory).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of non-transitory computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a microphone (e.g., voice inputs), a touch screen, a pointing device (commonly referred to as a mouse), a trackball, or a touch pad. Other input devices comprise satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

Turning now to FIG. 2, a block diagram 200 is illustrated, in accordance with an embodiment of the present invention, showing an exemplary system for customization of a health care spend value. It will be understood and appreciated that the computing system shown in FIG. 2 is merely an example of one suitable computing system environment and is not intended to suggest any limitation as to the scope of the user or functionality of embodiments of the present invention. Neither should the computing system be interpreted as having any dependency or requirement related to any single component or combination of components illustrated therein. Further, although the various block of FIG. 2 are shown with lines for the sake of clarity, in reality, delineating various components is not so clear, and metaphorically, the lines would more accurately be grey and fuzzy. In addition, any number of physical machines (such as computing devices or portions of computing devices shown in FIG. 1), virtual machines, data centers, endpoints, or combinations thereof may be employed to achieve the desired functionality within the scope of embodiments of the present invention.

The components of FIG. 2 are capable of communicating with a number of different entities or data sources such as healthcare data sources 204 for the collection of data (e.g., population data, patient data, demographic data, wellness data, financial data, etc.). This communication may utilize, without limitation, one or more local area networks (LANs) and/or wide area networks (WANs). Such networking environments are commonplace in offices, enterprise-wide computer networks, intranets, and the Internet. Accordingly, the network 202 is not further described herein. As used throughout this application, the term “healthcare data” is meant to be broad and encompass any type of healthcare information. The healthcare data may be specific to a single patient or a group of patients. The healthcare data may also be directed to a clinician or group of clinicians. For example, healthcare data as it relates to a clinician may include patients that the clinician treats.

The database 204 may include information from, for example, a hospital, a physician's office, a health information exchange, an urgent care clinic, and the like. Healthcare data received from this database 204 may include, but is not limited to, information that describes various aspects of the patient state, including patient vitals, lab results, biometrics, medication orders, diagnosis codes, condition codes, clinical orders, claims, patient demographic information, patient history, patient images, wellness programs, participation in wellness programs, and a variety of other information.

Laboratory and biometric data collected may include age, gender, lipids (HDL, LDL, and triglycerides), body mass index (BMI), and glucose/HbA1c. This information is collected and used in combination with medical claims data to provide health care spend values.

It should be noted that the database 204 shown as communicating with various components of the system 200 is provided by way of example only and are not intended to limit the scope of the present invention in any way. Further, the database 204 may be disparate from other databases such that the database 204 is not directly connected with another database. Also included in the system 200 is a data system 206 that includes a variety of data including one or more electronic health record (EHR) systems, claims database systems 208, wellness program system 210, demographic information for individuals and populations, and the like. The data system 206 may be communicatively coupled to network 202. Network 202 may comprise the Internet, and/or one or more public networks, private networks, other communications networks such as a cellular network, or similar network(s) for facilitating communication among devices connected through the network. In some embodiments, network 202 may be determined based on factors such as the source and destination of the information communicated over network 202, the path between the source and destination, or the nature of the information. For example, intra-organization or internal communication may use a private network or virtual private network (VPN). Moreover, in some embodiments items shown communicatively coupled to network 202 may be directly communicatively coupled to other items shown communicatively coupled to network 202.

Example operating environment 200 further includes provider user/clinician interface 214 communicatively coupled through network 202 to database 204 and data system 206. Although environment 200 depicts an indirect communicative coupling between interface 214 and other components through network 202, it is contemplated that an embodiment of interface 214 is communicatively coupled to data system 206 directly. An embodiment of interface 214 takes the form of a user interface operated by a software application or set of applications on a server or client computing device such as a personal computer, laptop, smartphone, or tablet computing device.

In an embodiment, the application is a Web-based application or applet or a distributed application. A provider clinician application facilitates accessing and receiving information such as from a user or health care provider or other entity (e.g., an insurance provider) about a specific patient or population of patients including patient history; health care resource data; variables measurements, time series, and predictions (including plotting or displaying the determined results, spend, etc.) described herein; or other health-related information, and facilitates the display of results, recommendations, predictions, orders, or the like, for example. In an embodiment, interface 214 also facilitates receiving orders or recommendations for the patient from the clinician/user, based on the spend predictions.

The system 200 further includes spend manager 212. Spend manager 212 may take the form of a user interface and application, which may be embodied as a software application operating on one or more mobile computing devices, tablets, smartphones, front-end terminals in communication with back-end computing systems, laptops, or other computing devices. In an embodiment, spend manager 212 includes a Web-based application or set of applications usable to manage user services provided by an embodiment of the disclosure. For example, in an embodiment, spend manager 212 facilitates processing, interpreting, accessing, storing, retrieving, and communicating information from data systems 206 and/or other data locations.

In application, numerous items of data including, but not limited to, demographic information, medical condition information, wellness program information, and the like, are stored in various components of the system 200. For instance, the data system 206 may store claims in the claims database systems 208 and wellness program information in the wellness program systems 210. Data may also be stored in the database 204. The data may be compiled such that relevant information is extracted. Relevant information may be any information that is to be included in the calculation of a health care spend value. For example, claims data may be extracted from International Statistical Classification of Diseases and Related Health Problems (ICD) codes. The relevant data may be evaluated by the spend manager 212 to provide a health care spend value. The spend manager 212 may also compute a present spend value (not future) or a combination of present and future spend values. The spend manager 212 is configured such that any of the variables (demographic information, wellness program information, etc.) may be manipulated to customize a spend value. For instance, if a facility is aware that they spend X amount average per member per year (PMPY) they could manipulate various inputs, such as adding or adjusting wellness programs, to see the effect on the PMPY spend.

The statistical methods utilized in the tool are described herein. A primary outcome of PMPY spend may be log transformed due to right skewed data. A multivariable repeated measures linear regression model may be used to predict log PMPY. Covariates may include age categorized, gender, hypertension, dyslipidemia, back pain, obesity, child birth, heart attack, chronic heart failure, peripheral vascular disease, cerebrovascular disease, pulmonary disease, rheumatologic disease, peptic ulcer disease, liver disease, diabetes, Hemiplegia or parplegia, cancer, AIDS, and depression/anxiety. Modifiable wellness programs may include health coaching, nutrition, counseling, preventative care, exercise programs, and weight loss programs. Log-transformed spend may be untransformed and Duan's Smearing estimator may be applied to account for retransformation bias. Predicted PMPY and 95% confidence interval estimates will then be used in the calculator. Secondary outcomes may be modeled using multivariable repeated measures regression models and may include the same covariates previously listed. Additional covariates/outcomes may be added to the calculator at any time.

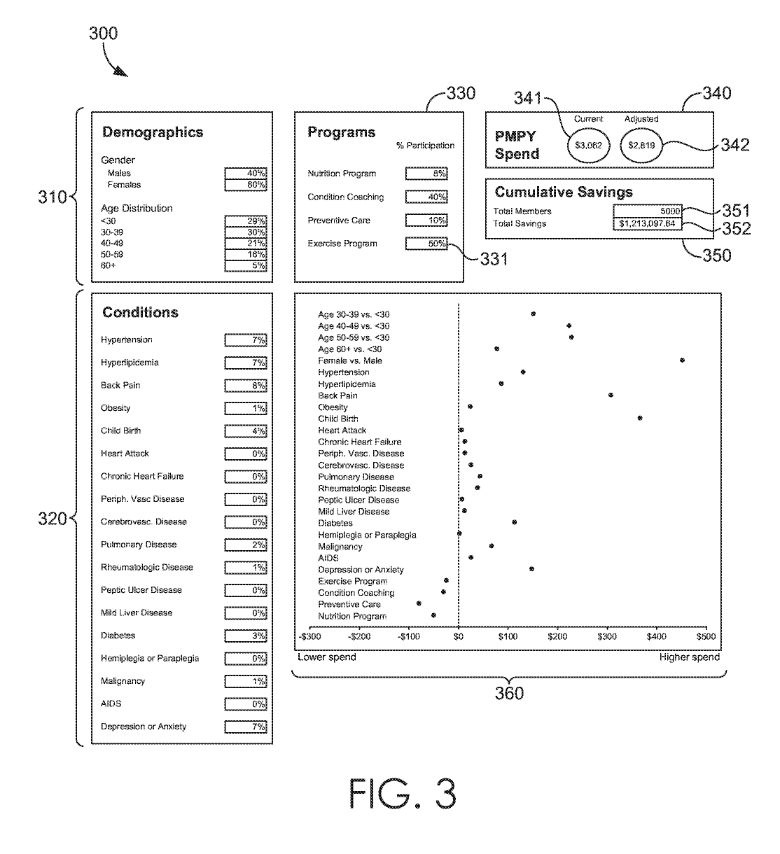

FIG. 3 is an exemplary graphical interface 300 of a predictive modeling interface. The interface 300 includes a demographic input area 310, a medical condition input area 320, a wellness program input area 330, and PMPY spend area 340, and savings area 350, and a spend display area 360. Each of the demographic input area 310, the medical condition input area 320, and the wellness program input area 330 is editable such that a user can customize the predictive model. A client may, for instance, input demographics specific to a particular location (e.g., a health clinic). The inputs may also be automatically populated using the information previously described (e.g., demographic information, wellness program information, medical condition information, etc.). The information may be received, for example, from an EHR, a patient lab, claims, etc. For example, a particular location, such as the health clinic previously referenced, may have 7% of the population with hypertension. Programs to address hypertension may be of interest to that user.

The PMPY spend area 340 includes a current PMPY spend indicator 341 and an adjusted PMPY spend indicator 342. The current PMPY spend indicator 341 indicates a current PMPY spend based on the inputs of one or more of the demographic input area 310, the medical condition input area 320, and the wellness program input area 330. The adjusted PMPY spend indicator 342 indicates what the PMPY spend would be based on one or more adjustments to the inputs. For instance, if the medical condition input area 320 is modified to reflect that 8% of the population is obese (rather than the 1% currently displayed in FIG. 3), the adjusted PMPY spend indicator 342 would increase as more money would be spent per member if more members are obese.

Similarly, the savings area 350 includes a total members indicator 351 that indicates a total number of members of the population. This is editable by a user to change the size of the population. The savings area 350 also includes a total savings area 352 indicating a total savings value. As with the adjusted PMPY spend indicator 342, the total savings area 352 automatically updates to reflect changes in the input values (e.g., changes in medical condition information, changes in demographics, etc.).

This tool/interface 300 is beneficial so that users can manipulate various inputs to see where the greater impacts are made when adjusting inputs. For example, based on the population, a nutrition program may not be found to make as much of an input on spend as an exercise program would. In a different population, the alternative may be the case where a nutrition program is indicated as more effective than an exercise program.

The PMPY spend area 340 and the savings area 350 are automatically populated based on the inputs of one or more of the demographic input area 310, the medical condition input area 320, and the wellness program input area 330. For instance, as explained above, if the medical condition input area 320 is modified to reflect that 8% of the population is obese (rather than the 1% currently displayed in FIG. 3), the PMPY spend area 340 would be automatically updated to show an increased PMPY spend and the savings area 350 would also be adjusted.

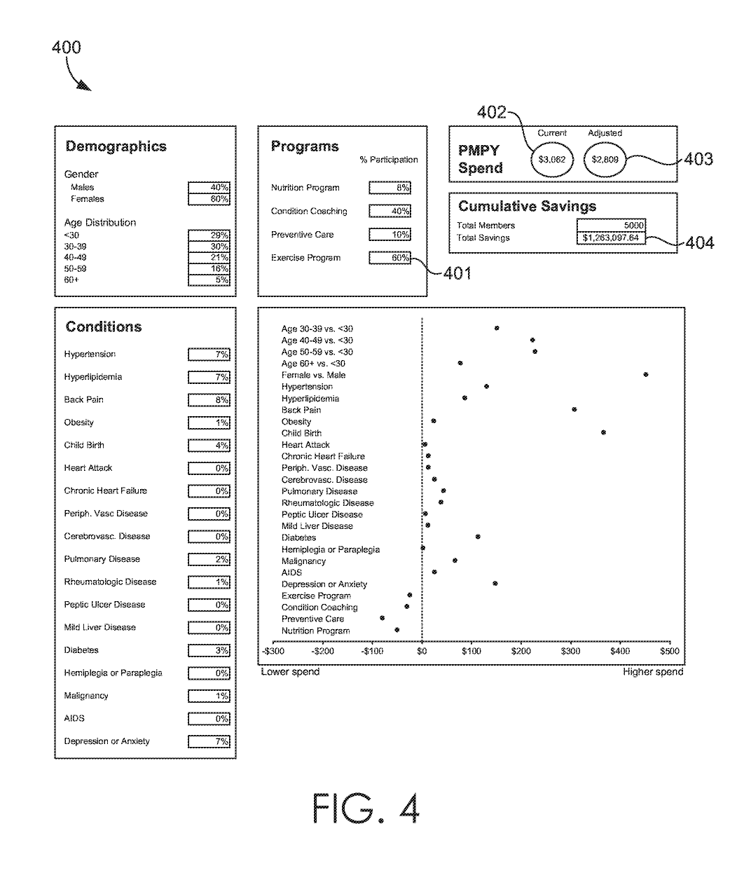

FIG. 4 provides an exemplary user interface 400 illustrating a modification and the effects thereof. In FIG. 4, a wellness program input is modified at indicator 401. The same indicator is shown as indicator 331 in FIG. 3. As shown in FIG. 3, the indicator 331 shows a 50% participation rate for an exercise program. The indicator 401 illustrates an increase in participation in the exercise program to 60%. The current PMPY spend indicator 402 is the same as the current PMPY spend indicator 341 of FIG. 3 as it indicates a current spend value and is not adjusted with input manipulations. The adjusted PMPY spend indicator 403 illustrates that, when compared to the adjusted PMPY spend indicator 342 of FIG. 3, the PMPY spend decreases when more members participate in an exercise program. Similarly, the total savings area 404 is automatically updated to reflect the updated savings with 60% participation.

In embodiments, the predictive modeling interface may be configured to provide recommendations to users regarding modifications. For instance, the predictive modeling tool may identify, through analysis of the inputs, that an adjustment to the exercise program would make a very large impact on the spend. As such, this information may be provided to a user. Additionally, incentive information may be provided related to modification of inputs. For example, if participation in exercise programs goes up with the offer of an incentive (e.g., gift card), that adjustment may be provided to a user as well as updated spend values.

In an embodiment, an additional layer for secondary outcomes is provided (in addition to spend as an outcome). The secondary outcomes may include a change in health risk (e.g., body mass index (BMI), blood pressure, lipids, and glucose/HbA1c) or a change in chronic conditions (e.g., diabetes control, hypertension, smoking, etc.). For example, the predictive modeling tool may identify that weight loss program participation decreases BMI, which decreases a risk for heart disease, etc. The outcome in this situation is not spend, but it is still very important and closely tied to spend. In an example, a patient that gets blood pressure and weight under control now may not be at as high of risk for a heart attack in ten years. That, ultimately, reduces spend values in the long term.

In embodiments, the predictive modeling tool first measures demographics associated with PMPY to identify PMPY spend. The estimates associated with demographics of a population do not typically change much unless the demographics of a population change drastically. For instance, a PMPY spend estimate for one year may be 32.97 and for the next may be 32.98. Any regression model may be used to measure the demographic information. Next, the tool measures medical conditions associated with PMPY. Here, the tool identifies averages associated with medical conditions. For example, the tool will identify that the average spend with the population of members having back pain is $5000 while the average spend with the population of members without back pain is only $3000. The next phase involves engagement with the PMPY. Here, incentive data may be collected from clients and compiled in one or more data sources. Exemplary incentive data sources may be weight loss challenges, financial incentives (e.g., gift cards, bonuses, reduction/match in insurance premiums), health coaching, walking programs, dieticians/nutrition programs, etc. The incentive data is included in the regression model and the tool/calculator may be updated with new incentive estimates. This provides users an estimate as to the effectiveness of incentives. The tool may also include detailed information regarding the engagement such as whether or not the engagement was successful (e.g., weight loss program with gift card was a success).

The tool of the present invention may provide estimates for one or more of a plurality of time periods. For example, the tool may provide estimates for one year out, two years out, three years out, or a combination thereof. This provides clients the ability to easily view the impact on the next year, 2 years after implementation, and additional years (or any other time period).

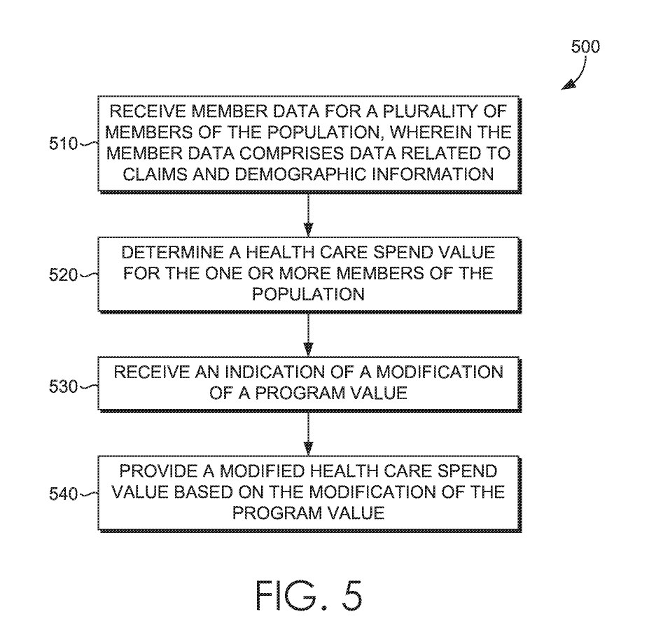

Turning now to FIG. 5, a flow diagram illustrating an exemplary method 500 is provided. Initially, at block 510, member data is received for a plurality of members of a population. The member data comprises data related to claims and demographic information. At block 520, a health care spend value is determined for the one or more members of the population. The health care spend value is determined based on the data related to claims and demographic information. The health care spend value may be on an individual basis or for an entire population. At block 530, an indication of a modification of a program value is received. At block 540, a modified health care spend value is provided based on the modification of the program value.

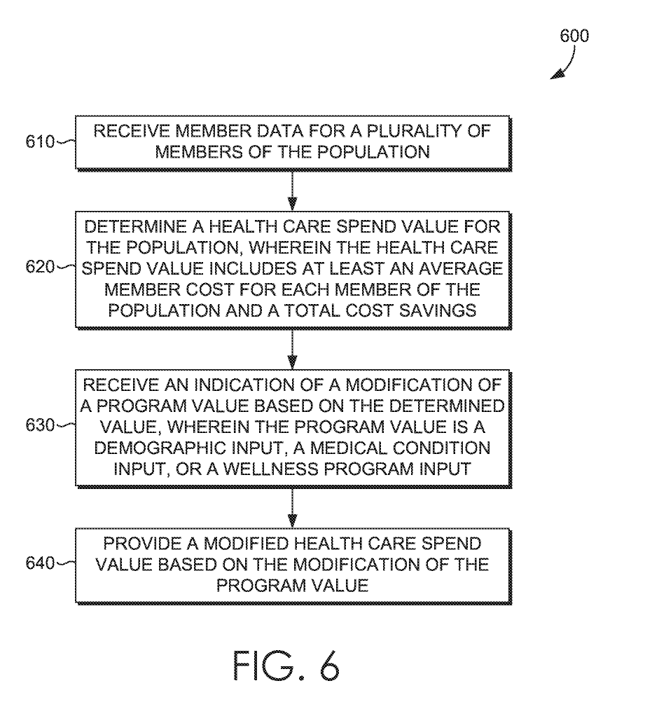

Turning now to FIG. 6, a flow diagram illustrating an exemplary method 600 is provided. Initially, at block 610, member data is received for a plurality of members of the population. At block 620, a health care spend value is determined for the population. The health care spend value includes at least an average member cost for each member of the population and a total cost savings. At block 630, an indication of a modification of a program value is received, wherein the program value is a demographic input, a medical condition input, or a wellness program input. At block 640, a modified health care spend value is provided based on the modification of the program value.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described. Accordingly, the scope of the invention is intended to be limited only by the following claims.

What is claimed is:

1. A computerized system comprising:
one or more processors; and
computer storage memory having computer-executable instructions stored thereon which, when executed by the processor, implement a method of predicting spend values for the population members, the method comprising:
(a) receiving a set of member data for one or more members of the population, wherein the set of member data comprises data related to claims and demographic information; and
(b) determining a health care spend value for the one or more members of the population based on the data related to claims and demographic information.

2. The computerized system of claim 1, further comprising:
receiving a modification of a program value, wherein the program value is one or more of a demographic value, a medical condition value, and a wellness program value; and
determining a modified health care spend value based on the modified program value.

3. The computerized system of claim 1, wherein the set of member data further comprises data related to at least one of (i) wellness or personal-health-assessment (PHA) information and (ii) electronic medical record (EMR) information.

4. The computerized system of claim 1, wherein the set of member data further comprises lab information and biometric data.

5. The computerized system of claim 1, wherein determining the health care spend value is based at least in part on the received set of member data.

6. The computerized system of claim 1, further comprising determining a secondary outcome in addition to the health care spend value.

7. The computerized system of claim 1, wherein the health care spend value includes at least an average member cost for each of the one or more members of the population.

8. The computerized system of claim 7, wherein the health care spend value further includes a total cost savings.

9. The computerized system of claim 1, wherein the demographic information is editable.

10. The computerized system of claim 1, wherein the claims data is extracted from one or more codes including an International Statistical Classification of Diseases and Related Health Problems (ICD) code.

11. The computerized system of claim 1, wherein one or more medical condition information is editable.

12. A method for predicting health care spend for a population, the method comprising:
receiving member data for a plurality of members of the population, wherein the set of member data comprises data related to claims and demographic information;
determining a health care spend value for the one or more members of the population based on the data related to the claims and the demographic information;
receiving an indication of a modification of a program value; and
providing a modified health care spend value based on the modification of the program value.

13. The method of claim 12, wherein the program value is one or more of a demographic value, a medical condition value, and a wellness program value.

14. The method of claim 12, wherein the set of member data further comprises data related to wellness or personal-health-assessment (PHA) information.

15. The method of claim 12, wherein the health care spend value includes at least an average member cost for each of the one or more members of the population.

16. The method of claim 15, wherein the health care spend value further includes a total cost savings.

17. The method of claim 12, wherein the health care spend value is provided for each of a plurality of time periods.

18. One or more computer-storage media having computer-executable instructions embodied thereon that, when executed by a computing device, cause the computing device to perform a method of determining health care spend for a population, the method comprising:
receiving member data for a plurality of members of the population, wherein the set of member data comprises data related to claims and demographic information;
determining a health care spend value for the population, wherein the health care spend value includes at least an average member cost for each member of the population and a total cost savings;
receiving an indication of a modification of a program value, wherein the program value is a demographic input, a medical condition input, or a wellness program input; and
providing a modified health care spend value based on the modification of the program value.

19. The media of claim 18, wherein the set of member data further comprises data related to wellness or personal-health-assessment (PHA) information.

20. The media of claim 18, further comprising providing the health care spend value for each of a plurality of time periods.
